(19) United States
(12) Patent Application Publication
(10) Pub. No.: US 2010/0128704 A1
(43) Pub. Date: May 27, 2010

(54) Mulitcasting, location services, payment methods and performance management in broadband wireless access networks

(76) Inventors: Pouya Taaghol, San Jose, CA (US); Muthaiah Venkatachalam, Beaverton, OR (US); Avishay Sharaga, Bet Nehemya (IL); Joey Chou, Scottsdale, AZ (US); David Johnston, Beaverton, OR (US)

Correspondence Address: INTEL CORPORATION;c/o CPA Global, P.O. BOX 52050, MINNEAPOLIS, MN, 55402, US

(21) Appl. No.: 12/387,056

(22) Filed: Apr. 27, 2009

Related U.S. Application Data
(60) Provisional application No. 61/048,126, filed on Apr. 25, 2008.

(51) Int. Cl. H04W 84/02

(52) U.S. Cl. 370/338

(57) ABSTRACT

Methods, apparatuses and systems for location discovery, electronic payment and multicast broadcast in a wireless broadband network disclosed.

### CROSS-REFERENCE TO RELATED APPLICATIONS

The present application claims benefit of priority under 35 U.S.C. §119(e) to U.S. provisional application Ser. No. 61/048,126, filed by the instant inventors on Apr. 25, 2008, the entire content of which is incorporated herein by reference.

### BACKGROUND OF THE INVENTION

It is becoming more important to be able to provide telecommunication services to subscribers which are relatively inexpensive as compared to cable and other land line technologies. Further, the increased use of mobile applications has resulted in much focus on developing wireless systems capable of delivering large amounts of data at high speed for mobile users.

Development of more efficient and higher bandwidth wireless networks has become increasingly important and addressing issues of how to maximize efficiencies of such networks is an ongoing. One such issue relates to efficient scheduling of transmissions between a base station and multiple user stations in a multiple access wireless network such as a network using orthogonal frequency division multiple access (OFDMA) protocols.

### BRIEF DESCRIPTION OF THE DRAWINGS

FIG. 1 is a block diagram illustrating a wireless broadband network according to various embodiments;

FIGS. 2-4 show an example USI system for MCBCS and respective control and data flows of the inventive embodiments;

FIG. 5 is an example architecture for WiMAX location service according to various embodiments;

FIG. 6 shows an exemplary LS discovery procedure according to various embodiments;

FIG. 7 shows an example method for the MS initiated Time to first fix enhancement;

FIG. 8 shows a method for Network initiated Time to first fix enhancement;

FIG. 9 shows a WiMAX PM Initialization state of the inventive embodiments;

FIG. 10 shows an example WiMAX PM Measurement process according to various embodiments;

FIG. 11 an example USI solution within WiMAX network according to certain embodiments;

FIG. 12 shows an example method for electronic payment (e-payment) via USI.

### DESCRIPTION OF THE INVENTION

While the following detailed description may describe example embodiments of the present invention in relation to broadband wireless metropolitan area networks (WMANs), the invention is not limited thereto and can be applied to other types of wireless networks where similar advantages may be obtained. Such networks specifically include, if applicable, wireless local area networks (WLANs), wireless personal area networks (WPANs) and/or wireless wide area networks (WWANs) such a cellular networks and the like. Further, while specific embodiments may be described in reference to wireless networks utilizing multi-user Orthogonal Frequency Division Multiplexing (OFDM) otherwise referred to as Orthogonal Frequency Division Multiple Access (OFDMA), the embodiments of present invention are not limited thereto and, for example, can be implemented using other air interfaces where suitably applicable.

The following inventive embodiments may be used in a variety of applications including transmitters and receivers of a radio system, although the present invention is not limited in this respect. Radio systems specifically included within the scope of the present invention include, but are not limited to, network interface cards (NICs), network adaptors, fixed or mobile access points, mesh stations, base stations, hybrid coordinators (HCs), gateways, bridges, hubs, routers or other network peripherals. Further, the radio systems within the scope of the invention may include cellular radiotelephone systems, satellite systems, personal communication systems (PCS), two-way radio systems and two-way pagers as well as computing devices including such radio systems such as personal computers (PCs) and related peripherals, personal digital assistants (PDAs), personal computing accessories, hand-held communication devices and all existing and future arising systems which may be related in nature and to which the principles of the inventive embodiments could be suitably applied.

Networks that may employ embodiments of the present invention may be a high throughput wireless communication network such as those contemplated by various IEEE 802.16 standards for fixed and/or mobile broadband wireless access (BWA), a 3^{rd} Generation Partnership Project (3GPP) Long Term Evolution (LTE) mobile phone network or other type of high bandwidth WMAN, WLAN or WWAN.

In the IEEE 802.16 standards (sometimes referred to as WiMAX, an acronym that stands for Worldwide Interoperability for Microwave Access), two principle communicating wireless network nodes are defined including the Base Station (BS) and the Subscriber Station (SS). However, these terms are used in a generic manner throughout this specification and their denotation in this respect is in no way intended to limit the inventive embodiments to any particular type of network.

In one example configuration, a base station is a managing entity which controls the wireless communications between subscriber stations and a provider network and/or potentially between the subscriber stations themselves. Subscriber stations in turn, may facilitate various service connections of other devices to a network via a private or public local area network (LAN), although the embodiments are not limited in this respect.

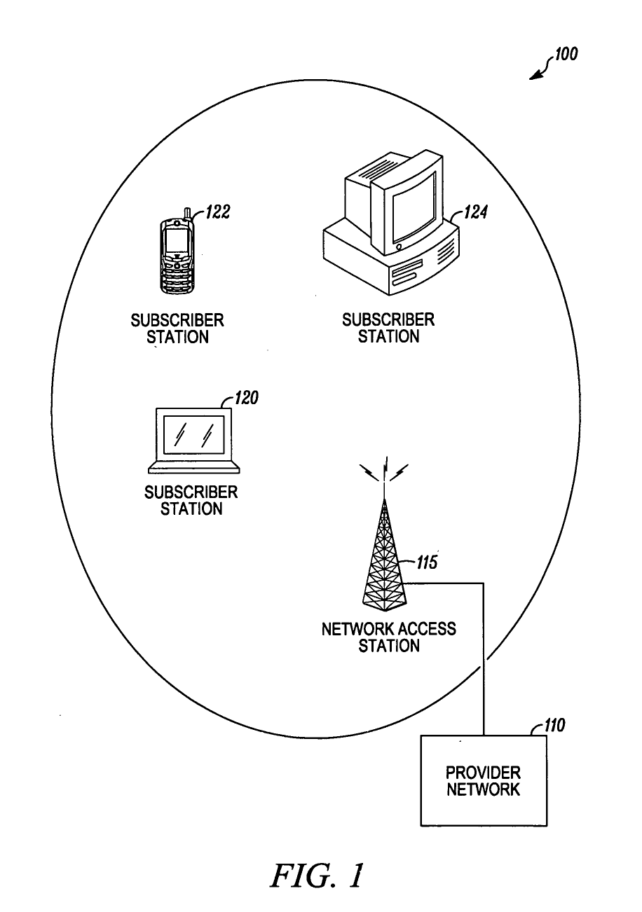

In the example configuration of FIG. 1, a network access station, e.g., base station 115 is a managing entity which controls the wireless communications between subscriber stations 120-124 and provider network 110 and/or potentially between the subscriber stations themselves. Subscriber stations 120-124 in turn, may facilitate various service connections of other devices (not shown) to network 110 via a private or public local area network (LAN), although the embodiments are not limited in this respect.

In one implementation base station 115 may send data to subscriber stations 120-124 in downlink (DL) and receives data from stations 120-124 in uplink (UL) in a sequence of transmission time intervals (TTIs). A TTI in some network configurations such as IEEE 802.16 standards may be referred to as an air frame or a frame. In other network configurations, TTIs may be referred to as a packet. Provider network 110 may be an amalgam of network(s) run by a network service provider (NSP) or other entities to connect a subscriber to Internet Application Service Provider (iASPs) and may consist of multiple different equipment such as access gateways, universal services interface (USI) server(s), authentication and accounting equipment, core services network (CSN) and the like. In the following embodiments, description in made in reference to WiMAX networks although the inventive embodiments may be applicable to various alternative network types and protocols.

Multicast/Broadcast Services (MCBCS) Using Universal Services Interface (USD in a WiMAX network

Two broad categories of MCBCS services are possible over WiMAX: (i) MCBCS for/by the WiMAX operator: service specifically tailored for/by the NSP for a WiMAX end host; and (ii) MCBCS on the Internet: service NOT tailored for a WiMAX end host such as targeting and delivering through the USI.

MCBCS Delivery through USI

Several MCBCS and pay-per-view (PPV) services available on the internet today. Most of these services though multicast in nature, are often delivered as multi-unicasts to the end hosts. This leads to inefficient use of last mile bandwidth and especially does not scale well with wireless last miles configurations. Thus a need exists for an efficient mechanism to bring all of MCBCS services on the internet to a WiMAX end host. Enabling internet based MCBCS through USI can solve this problem of efficiency on the wireless link since the USI system can be the focal point of such MCBCS traffic from the internet and can deliver such traffic through the existing MCBCS data path within the NSP/NAP.

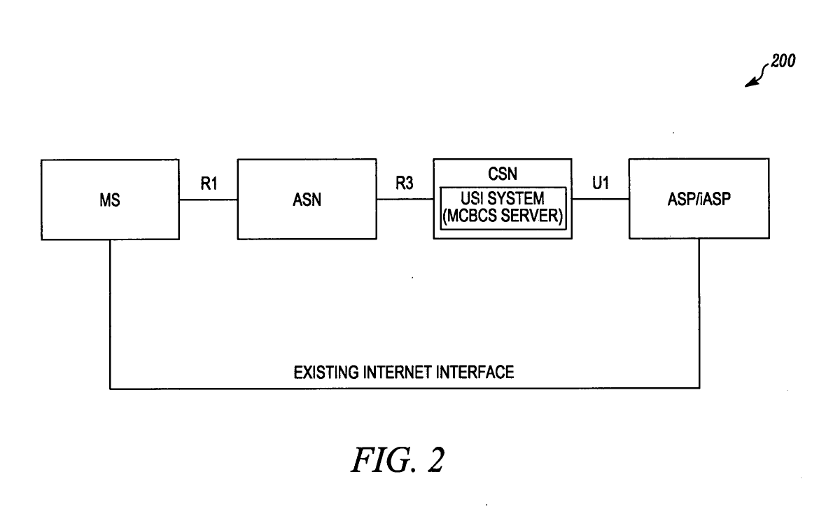

Although MCBCS architecture is not finalized, it is widely expected to have a MCBCS server in the core services network (CSN). MCBCS services on the internet can be enabled via USI by collocating the MCBCS server in the USI system as shown in FIG. 2. The MCBCS interactions on U1 interface include: MCBCS Control/signaling information and MCBCS data information.

The MCBSC Control on U1 may include: a. Service guide delivery (iASP→USI) or request (USI→iASP) which contains the service/program guide of the iASP; b. Security context delivery (iASP→USI) or request (USI→iASP): example: DRM enabled or not; if yes, DRM related context exchange; and/or c. QoS requirements for the service (iASP→USI) or request (USI→iASP). Eg: Favorable Peak/Avg rates; tolerable latencies.

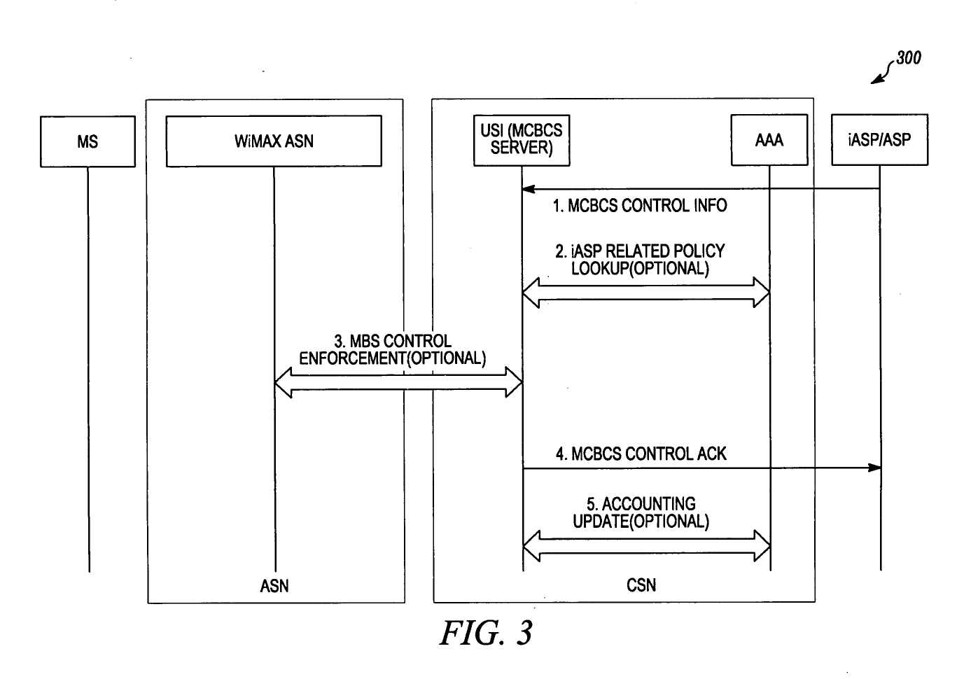

The MCBCS control flow on U1 is shown in FIG. 3 and includes: Step 1: The iASP signals the MCBCS related control information (eg: service guide/QoS information etc) is exchanged on U1. Alternatively the USI system can request such control information from the iASP in a prior step for which the iASP can respond as shown in step-1. Step 2: The USI system may lookup related policy information from the AAA with regards to the iASP. This is an optional procedure and could involve operations like authenticating the iASP, authenticating the control information on U1 is within policy etc. Step 3: The USI system may enforce this control information within the network access provider (NAP) and/or NSP. Step 4: The USI system responds to the iASP with an acknowledgement (ACK). Step 5: The USI system may perform an accounting update with regard to the iASP.

MCBCS Data on U1

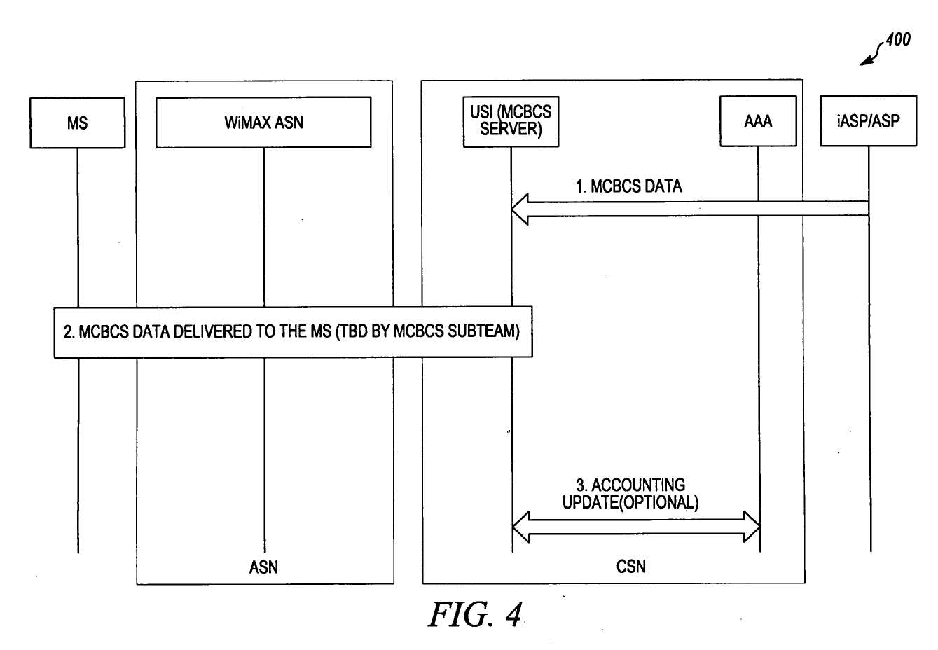

The flow in FIG. 4 shows the actual MCBCS data on U1 (iASP→USI). The process 400 for this exchange may include: Step 1: iASP sends the MCBCS data to the MCBCS server in the USI system; Step 2: MCBCS data is delivered to the MS via the MCBCS data path that achieves better efficiency as opposed to a non-efficient multi-unicast data path that would be used if this MCBCS data came directly from the internet to the MS; Step 3: The USI system may perform an accounting update with regard to the MS and/or the iASP.

USI can be used by the iASPs (like Google® and Yahoo®) to judge the user presence on WiMAX networks and provide value add services based on the presence information. The inventive embodiments provide one such architecture and procedure using USI for the same.

A key advantage of the proposed approach is as follows: When using USI for MCBCS, the MCBCS data from iASPs in the internet is delivered to the MS via the MCBCS data path that achieves better efficiency as opposed to a non-efficient multi-unicast data path that would be used if this MCBCS data came directly from the Internet to the MS. This is a huge efficiency gain for a WiMAX operator on the wireless link which translates to increased spare capacity on the network which can be used for other services.

USI is a novel architecture that may very well change the way that value add services are deployed in broadband wireless networks. Presence is a key component of USI and these embodiments propose a simple and scaleable way for the iASPs to extract user and device presence from WiMAX networks to provide enhanced services.

WiMAX Location Protocol

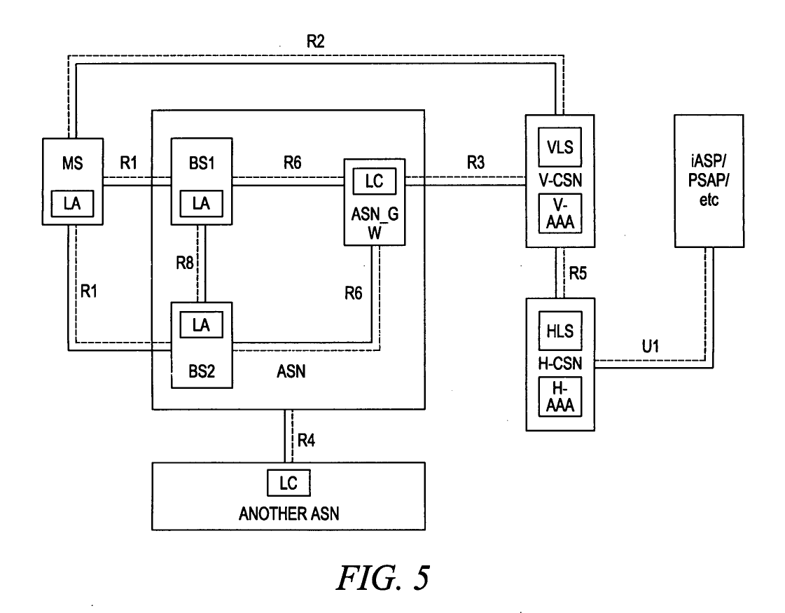

WiMAX has location capabilities being defined for the WiMAX network in the WiMAX Forum. The architecture for WiMAX location as defined in the WiMAX forum is shown in FIG. 5. The key interface here is the R2 interface which is used for communication between the WiMAX mobile station (MS) and the WiMAX location server (LS).

Embodiments of the invention describe the WiMAX location protocol (WLP) which is used primarily for the MS to interact with the LS and vice versa. This protocol shall be used for R2 interface. The main purpose of the protocol is to support the following aspects of the WiMAX location: a. location server discovery; and b. providing GPS assistance to the MS in both MS-initiated and network initiated scenarios. GPS assistance is needed to help the MS get the satellite fixes with minimal delay, especially when the MS is indoors where GPS coverage doesn't work well.

The prominent features of WLP include LS discovery, One time and periodic location, and support for GPS assistance such as Ephemeris, Almanac, and/or Broadcast security and privacy.

OMA SUPL [1] is an existing protocol that can be used for this purpose. But, SUPL has the following key issues. The cost of the SLP (SUPL location platform in the NW) can be prohibitive which may impact smaller companies ability to participate. SUPL is just the “cover” protocol which means actual positioning is done underneath by RRLP/RRC/TIA-801 and there is a very high complexity. The SUPL INIT procedure is extremely cellular centric with the three options being: 1. WAP push; 2. MT SMS or 3. (IMS) SIP Push. Push does not work well for PC platforms and security issues such as, how to secure R2 when using SUPL, given that SUPL does not use AAA framework. Further, roaming is suboptimal, home SLP is involved in many of the transactions even though visited SLP can do the job. For WiMAX location based services (LBS), roaming is much simplified as most of the transactions take place with V-LS. Lastly, OMA SUPL has a lot of other features that are irrelevant to WiMAX location effort. These include several documents spanning several 100s of pages and several 10s of messages whereas only 3-4 messages are standardized in WLP.

The key aspects of WLP are (i) LS discovery; (ii) time to first fix enhancement (MS initiated); and (iii) time to first fix enhancement (network initiated).

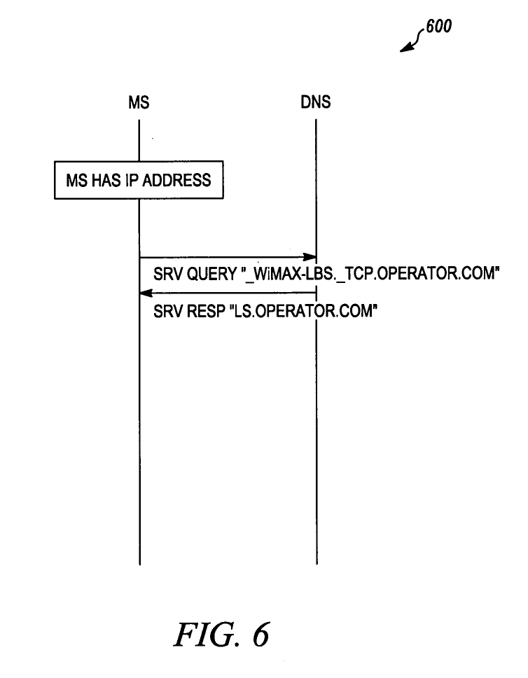

An exemplary LS discovery method 600 is shown in FIG. 6. In certain embodiments, LS Discovery will use DNS SRV records. The MS can initiate the DNS SRV query once it has an IP address. Thus it does not need incompatible technologies like WAP PUSH, MT SMS etc.

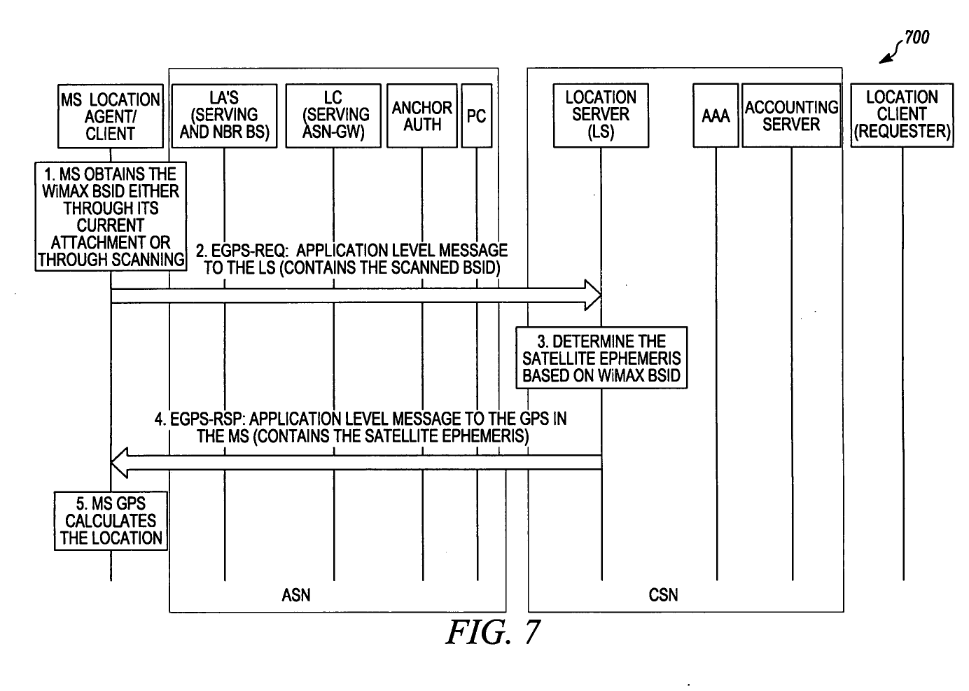

A method 700 for the MS initiated Time to first fix enhancement is shown in FIG. 7. A basic premise in this embodiment is that the MS obtains the satellite assistance from the LS by sending a request on Step-2 and a response on Step-4. In one example embodiment, these steps are executed on R2 and hence they belong to the WLP.

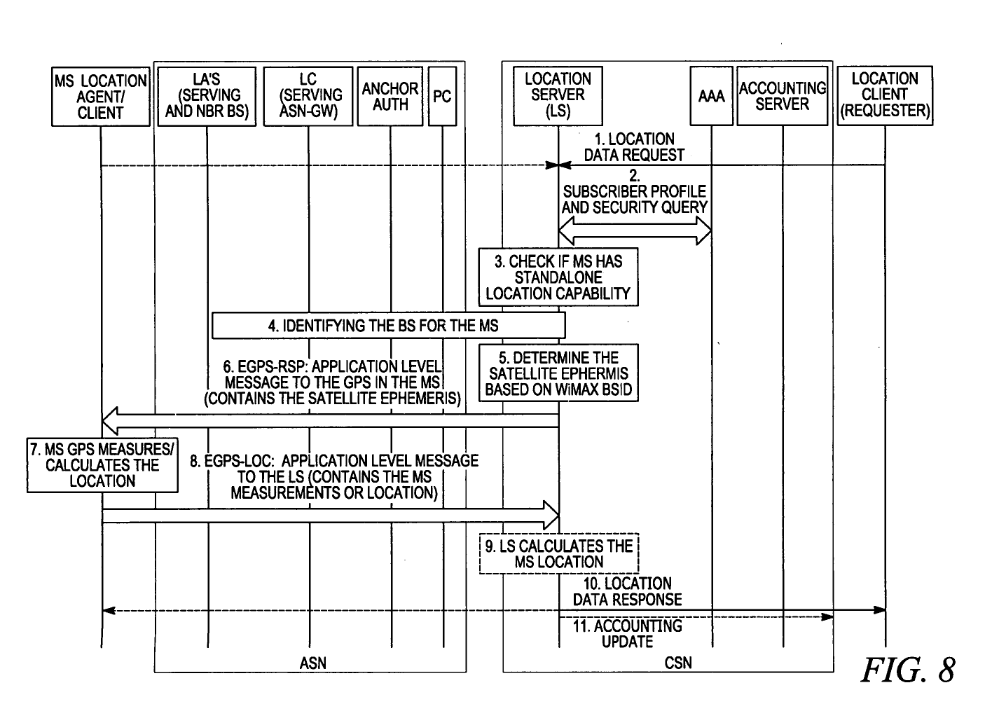

A method 800 for Network initiated Time to first fix enhancement is shown in FIG. 8 which is similar to FIG. 7 except that the network initiates the location query rather than the MS. Here, steps-6-8 are executed on the R2 interface and similarly belong to the WLP.

WLP MESSAGING: The key messages in WLP are EGPS-REQ, EGPS-RSP and EGPS-LOC. Exemplary formats for these messages are described below in reference to Tables. 1-4.

All of the WLP messages have a common WLP header, which is shown in Table 1.

TABLE 1
WLP header

| Field | Length of Field | M/O | Notes |
|---|---|---|---|
| Message length | 4 bytes | M | |
| Version | 1 byte | M | |
| Transaction ID | 2 bytes | M | |
| Message Type | 1 byte | M | MT = 0 for EGPS-REQ |
| | | | MT = 1 for EGPS-RSP |
| | | | MT = 2 for EGPS-LOC |

TABLE 2
EGPS-REQ message parameters

| IE | Reference | M/O | Notes |
|---|---|---|---|
| Serving BS ID | | M | The identifier of Serving or |
| | | | scanned BS ID |
| Requested info | | M | 1 Byte long bit map of the |
| from LS | | | requested info: |
| | | | Bit 0: Time aid: coarse time |
| | | | aid from the LS for GPS |
| | | | measurements |
| | | | Bit 1: Location aid: coarse |
| | | | location aiding to assist the |
| | | | GPS measurements |
| | | | Bit 2: Request for GPS |
| | | | Almanac |
| | | | Bit 3: Request for Satellite |
| | | | Ephemeris |
| | | | Bits 4-7: Reserved bits |
| Aiding Mask | | O | Aiding Mask for the satellites |
| | | | (32 bit quantity, 1 bit per |
| | | | satellite) |
| | | | Bit set => ephemeris for the |
| | | | satellite requested |

TABLE 3
EGPS-RSP message parameters

| IE | Reference | M/O | Notes |
|---|---|---|---|
| Serving/Scanned | | O | Location of the BSID. Included |
| BS ID location | | | if location aiding is requested |
| | | | by the MS for MS initiated TTF |
| | | | enhancements. For network |
| | | | initiated TTF enhancement, this |
| | | | parameter is always included. |
| >sign of | | O | North or south |
| latitude | | | |
| >latitude | | O | Integer (0 . . . 2\hat{ }23 − 1). |
| | | | The latitude encoded value |
| | | | (N) is derived from the actual |
| | | | latitude X in degrees (0° . . . 90°) |
| | | | by this formula: |
| | | | N <= 2\hat{ }23 X/90 < N + 1 |
| >longitude | | O | Integer (−2\hat{ }23 . . . 2\hat{ }23 − 1). |
| | | | The longitude encoded value (N) |
| | | | is derived from the actual |
| | | | longitude X in degrees |
| | | | (−180° . . . +180°) by this formula: |
| | | | N <= 2\hat{ }24 X/360 < N + 1 |
| >uncertainty | | O | semi major, semi minor, major |
| ellipse | | | axis. Refer to Annex A in the |
| | | | LBS Spec. |
| >confidence | | O | Represents the confidence by |
| level | | | which the position of a target |
| | | | entity is known to be within the |
| | | | shape description (i.e., |
| | | | uncertainty ellipse for 2D |
| | | | description, uncertainty |
| | | | ellipsoid for 3D description) |
| | | | and is expressed as a percentage. |
| | | | This is an integer (0 . . . 100). |
| >Z height | | O | Provides altitude information in |
| | | | meters. |
| | | | Integer (0 . . . 2\hat{ }15 − 1). Refer to |
| | | | annex A for details |
| >Z height | | O | Contains the altitude |
| uncertainty | | | uncertainty code. Refer to |
| | | | Annex A for details |
| Time aid | | O | Included if time aiding is |
| | | | requested by the MS for MS |
| | | | initiated TTF enhancements. |
| | | | For network initiated TTF |
| | | | enhancement, this parameter is |
| | | | always included. |
| Satellite | | O | Included, if requested by MS, |
| Ephemeris | | | for the set of satellites in the |
| | | | aiding mask for MS initiated. |
| GPS Almanac | | O | Included, if requested by MS, |
| | | | for the set of satellites in the |
| | | | aiding mask for MS initiated. |
| Error code | | O | Included in the event of an |
| | | | error. Please see LBS document |
| | | | for the codes |

TABLE 4
EGPS-LOC message parameters

| IE | Reference | M/O | Notes |
|---|---|---|---|
| MS location | | M | Location of the MS as |
| | | | calculated by it. |
| >Timestamp | | M | Timestamp when location was |
| | | | calculated |
| >sign of | | M | North or south |
| latitude | | | |
| >latitude | | M | Integer (0 . . . 2\hat{ }23 − 1). |
| | | | The latitude encoded value (N) |
| | | | is derived from the actual |
| | | | latitude X in degrees (0° . . . 90°) |
| | | | by this formula: |
| | | | N <= 2\hat{ }23 X/90 < N + 1 |
| >longitude | | M | Integer (−2\hat{ }23 . . . 2\hat{ }23 − 1). |
| | | | The longitude encoded value |
| | | | (N) is derived from the actual |
| | | | longitude X in degrees |
| | | | (−180° . . . +180°) by this formula: |
| | | | N <= 2\hat{ }24 X/360 < N + 1 |
| >uncertainty | | O | semi major, semi minor, major |
| ellipse | | | axis. Refer to Annex A in the |
| | | | LBS Spec. |
| >confidence | | O | Represents the confidence by |
| level | | | which the position of a target |
| | | | entity is known to be within |
| | | | the shape description (i.e., |
| | | | uncertainty ellipse for 2D |
| | | | description, uncertainty |
| | | | ellipsoid for 3D description) |
| | | | and is expressed as a percentage. |
| | | | This is an integer (0 . . . 100). |
| >Z height | | O | Provides altitude information |
| | | | in meters. |
| | | | Integer (0 . . . 2\hat{ }15 − 1). Refer to |
| | | | annex A for details |
| >Z height | | O | Contains the altitude |
| uncertainty | | | uncertainty code. Refer to |
| | | | Annex A for details |
| Error code | | O | Included in the event of an |
| | | | error. Please see LBS |
| | | | document for the codes |

TCP is the main transport for WLP and the encoding used could be TLV or ASN1. To date SUPL is the main protocol available, but that has several limitations for its use in WiMAX as noted above.

The present WLP solution overcomes many or all of the above issues encountered with SUPL. It is very simple, easy to deploy and extremely IP/IETF friendly and hence is tailored much better for Intel platforms as compared to SUPL, which is tailored better for cellular platforms.

Method and System of WiMAX Performance Management

There have been concerns on the mobile Internet performance in the initial WiMAX deployments. Therefore, a 100 KPI (Key Performance Indicator) counters have been proposed to characterize and fine tune WiMAX network performance. The following embodiments relate to a novel method to monitor WiMAX network performance.

System simulation is commonly used during the design phase to evaluate the performance of a wireless communication system. However, most operators are more interested in the performance of the system being deployed, or perceived by end users. Performance management is intended to collect, analyze, and report performance data for the purpose of monitoring and correcting the behavior and effectiveness of the network, and to aid in planning, provisioning, maintenance and the measurement of quality of service.

As opposed to 2G and 2.5G mobile networks that are largely TDM-based where transmission is tuned for voice with data as an add-on, the performance measurement for WiMAX is much more complicated since it is an all-IP mobile network.

It will be a daunting task to capture the mobile WiMAX performance in real-time. Therefore, this invention discloses a novel method to collect peak and mean parameters that are used to characterize WiMAX key performance indicators, including throughput, network entry latency, handover latency, CID, service flow, and subscriber mode statistics.

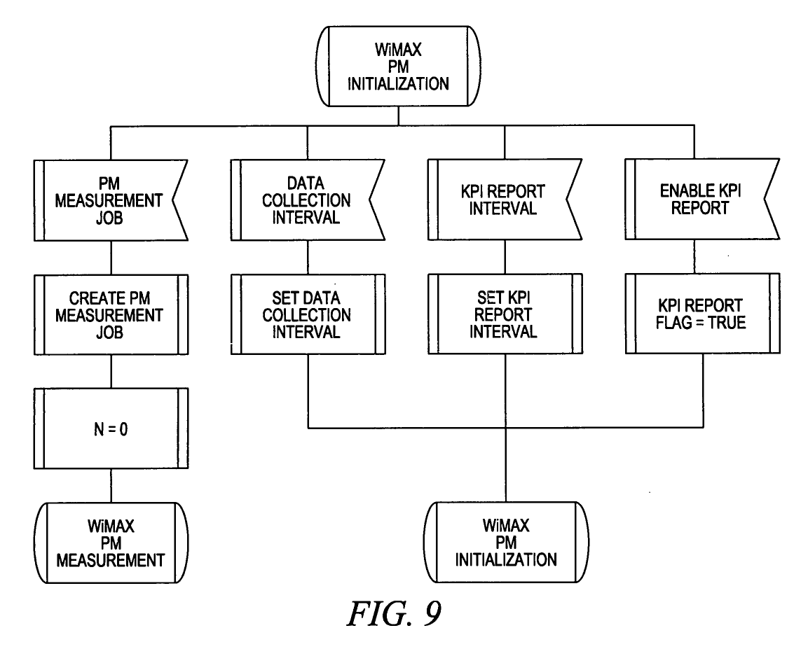

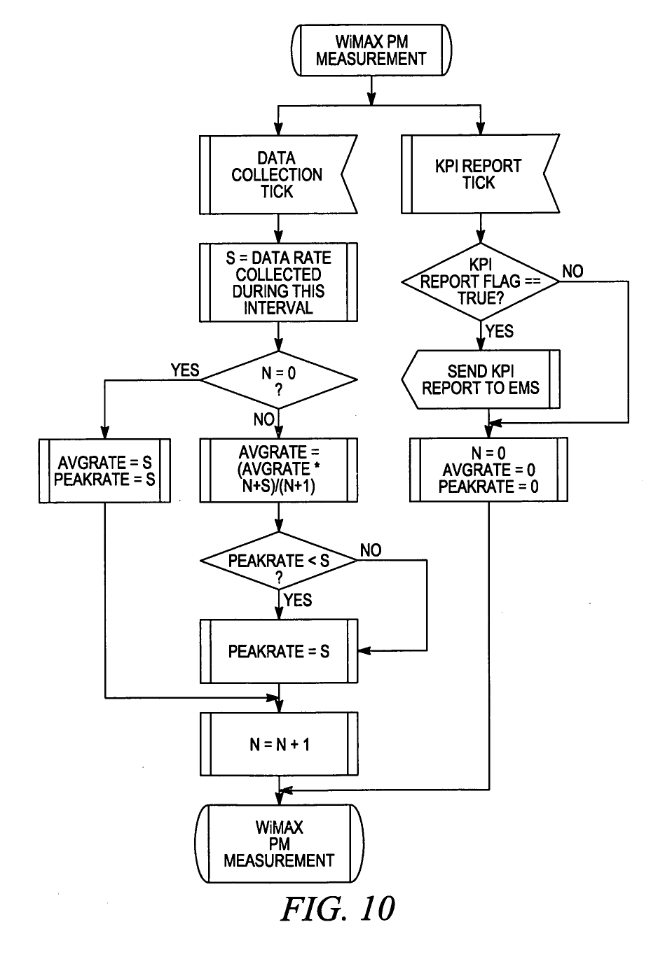

WiMAX performance management algorithm is described in SDL diagrams of FIGS. 9 and 10. FIG. 9 shows the WiMAX PM Initialization state that consists of the following input signals: (1) PM Measurement Job—create specific PM measurement job (e.g. throughput, handoff latency, . . . ), and initialize parameter N that is the index of measurement samples. (2) Data Collection Interval—set the data collection interval that determines the interval that the aggregate of data rate will be collected. For example, if the interval is 10 ms, the throughput PKI will collect the data in bytes that are transmitted in this 10 ms interval. (3) KPI Report Interval—set the KPI Report Interval that determines when the KPI data is to be reported to EMS (Element Management System); and (4) Enable KPI Report—set the flag determines which KPI data is to be or not to be reported.

FIG. 10 depicts the WiMAX PM Measurement process. A Data Collection Tick is generated in each Data Collection Interval to trigger the PM measurement. It includes only three parameters for each measurement job that have minimum overhead for network elements.
S—the data being collected in this interval
AvgRate—mean data rate
PeakRate—peak data rate

A KPI Report Tick is generated in each KPI Report Interval. If the KPI Report flag for a corresponding job is enable, then the KPI report will be sent to EMS, and the parameters will be reset.

Secure Payments over Universal Services Interface

Service providers have been looking for a technology that enables convergence of the service layer such that value add services can be easily deployed. To fill this gap, the mobile industry (more specifically 3GPP) has created a comprehensive all-IP network named IP Multimedia Subsystem (IMS). The promise of convergence by IMS is being weighed against its complexity both on the network side and the client device side. This has led the industry to question suitability of IMS as THE convergence technology of choice. However, the IMS complexity and the fact that almost all data services come from the Internet and not the operator, it becomes important to create a value for an operator in the Internet model.

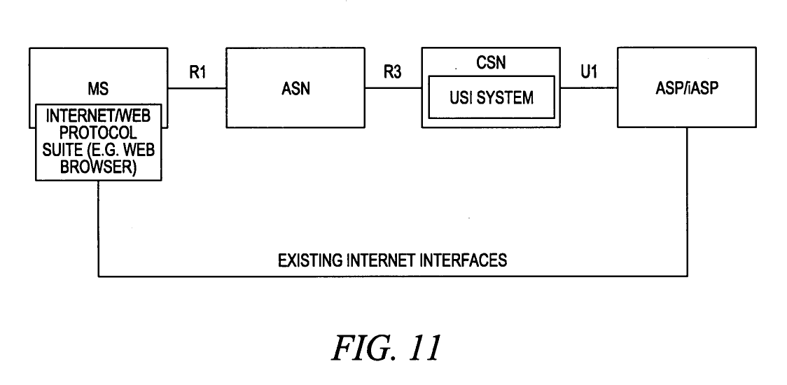

The Universal Service Interface (USI) is an industry-wide initiative in WiMAX Forum that enables the service provider to sell value-add services by simple interfacing to content providers. FIG. 11 shows an example USI solution within WiMAX network according to certain embodiments.

Embodiments of the invention relate to a comprehensive method that enables the user on a USI-enabled WiMAX network to send secure electronic payment to any Internet Application Service Provider (iASP). This electronic payment could be posted into the user's monthly access charges of his/her WiMAX service provider. This technology could be used to enable very interesting use cases where a user on a small mobile device (with limited input/output capability) could purchase airline tickets online and have the charges posted on his mobile bill. Another example is exchange of electronic money between friends (e.g. to split the restaurant check). In this process, the service provider (his designated host of the service) could collect a small percentage of the transaction as the service fee.

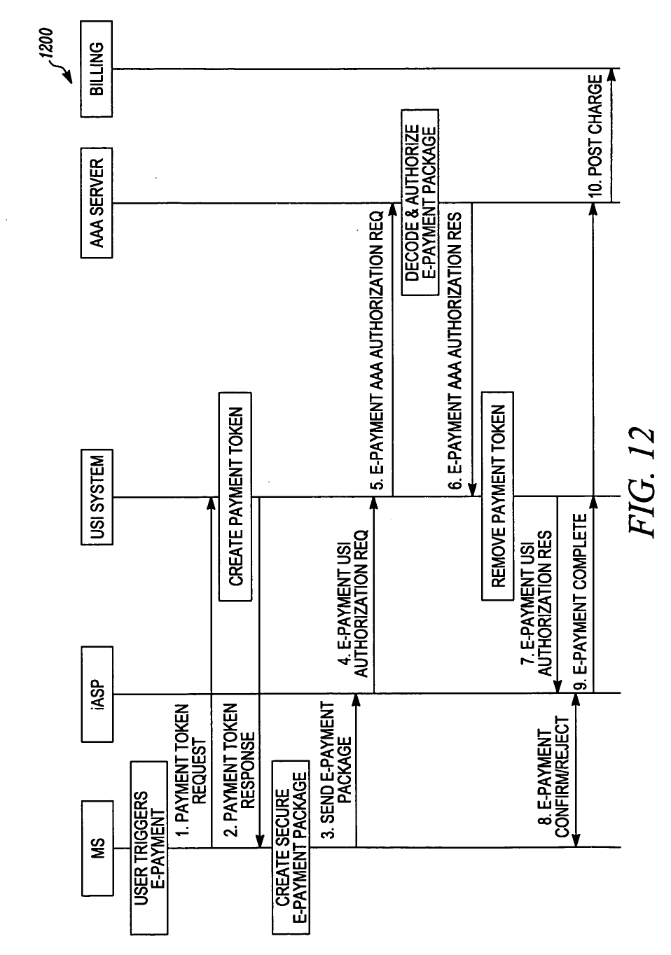

FIG. 12 shows an example method 1200 for electronic payment (e-payment) via USI. The user triggers an e-payment option. The thin USI client on the device requests a payment token from the USI Server. Payment token is created uniquely and it is only valid for one time use. In other words, when a token is used for a payment it is flushed from the USI System. The payment token prevents from repeat payment requests by the iASP. This token has no financial value. This Payment Token Request is sent in a secure communication tunnel between the MS and the USI Server and may include: USI User Identity, Payment amount, Currency, and ASP Domain Name

A Payment Token is sent back to the MS. Payment Token is sent in a secure communication tunnel between the MS and the USI Server. The MS sends the Payment Package. The MS uses the Payment Token along side other parameters to create the E-Payment Package and the encryption key. The USI Payment Key is defined as follows:
UPK=The most significant bytes of HMAC-SHA256(EMSK, payment-tag) (or of any other appropriate Key Derivation Function)

payment-tag=USI-User-identity+payment-amount+ASP-domain-name+payment-token

The Payment Package includes the following parameters:
Payment Token (unencrypted)
Payment amount (encrypted by UPK)
Currency (encrypted by UPK)
Payment token (encrypted by UPK)
ASP Domain Name (encrypted by UPK)

The Payment Package could be appended to a URL as follows: wORLDwideweb.asp-name.com/usi-payment?package=1feea719823rdfwsdwdajjxzsshweiudnak

The text after package demonstrates the encrypted e-payment package. The iASP sends an E-Payment USI Authorization Request towards the USI System of the WiMAX operator. This message includes the following parameter:
Payment Package

Upon receipt of this message, the USI system can look up the payment token validity. If the token number presented does not exist, the e-payment process will be rejected. If the token number is valid, the USI System looks up the USI User Identity associated with the token number and constructs the E-Payment AAA Authorization Request which includes:
User Identity
Payment amount
Currency
ASP Domain Name
Payment Package

Upon receipt of this message, the AAA Server first verifies to see if the user is subscribed to USI Payment service. If negative, a rejection message is sent back to the USI system. Otherwise, the AAA server constructs the UPK and decrypts the payment package. If the user profile allows for such financial amount of transition and the content in the package matches with the payment amount/currency/ASP-Name accompanied in clear text, an accept response is formed. The E-Payment AAA Authorization Response includes:
User Identity
Authorized Payment Amount
Currency
ASP Domain Name

Upon receipt of this response, the USI System constructs a message towards iASP indicating the result of e-payment authorization and removes the payment token from the system. The response includes:
User Identity
Payment Token
Authorized Payment Amount
Currency

The rest of the transaction is completed between the iASP and the MS.

Upon success, a success confirmation is propagated from the iASP to the USI System to the AAA Server. This message at least includes the USI User Identity.

In comparison with traditional IMS (IP Multimedia System), the present solution is far more simplified and easier to implement (fewer nodes, simpler protocols). The signaling protocol proposed for secure multimedia session control is XML exchanges over HTTPS. In comparison with traditional Session Initiation Protocol (SIP) used in IMS framework, the present inventive scheme (XML/HTTPS) has the following advantages:
HTTPS is an absolute commodity in notebooks and handhelds
Guaranteed interoperability
Built in security
Can easily integrate to web applications to create value-add services
Takes advantage of the secure device and user identity in WiMAX devices

The alternative architecture, i.e., the current IP Multimedia Systems (IMS) developed by 3GPP, is quite sophisticated and expensive to develop both on the network side and the client device side and only allows for walled-garden services (not Internet services). Thus the inventive solution is more secure, reliable, and/or Internet friendly.

Unless contrary to physical possibility, the inventors envision the methods described herein: (i) may be performed in any sequence and/or in any combination; and (ii) the components of respective embodiments may be combined in any manner.

Although there have been described example embodiments of this novel invention, many variations and modifications are possible without departing from the scope of the invention. Accordingly the inventive embodiments are not limited by the specific disclosure above, but rather should be limited only by the scope of the appended claims and their legal equivalents.

The invention claimed is:

1. The methods as shown and described herein.

2. An apparatus to perform the methods shown and described herein.
